(19) United States
(12) Patent Application Publication
(10) Pub. No.: US 2026/0238129 A1
(43) Pub. Date: Aug. 13, 2026

(54) POWER SUPPLY CONTROL DEVICE

(71) Applicants: Yoshiki TAKABATAKE, Yokohama-shi (JP); Yuichi UEDA, Ebina-shi (JP)

(72) Inventors: Yoshiki TAKABATAKE, Yokohama-shi (JP); Yuichi UEDA, Ebina-shi (JP)

(73) Assignee: MITSUMI ELECTRIC CO., LTD., Tokyo (JP)

(21) Appl. No.: 19/534,839

(22) Filed: Feb. 10, 2026

(30) Foreign Application Priority Data
Feb. 12, 2025 (JP) 2025-020685

(51) Int. Cl. H02M 3/158; H02M 1/00

(52) U.S. Cl. CPC H02M 3/158; H02M 1/0009

(57) ABSTRACT

A power supply control device includes: a first transistor that is connected between an input terminal and an output terminal and that controls a current supplied from the input terminal to the output terminal; a regulator control circuit that detects a voltage of the output terminal and controls the first transistor so that the voltage of the output terminal is at a constant level; a reverse-current detection circuit that detects a reverse current state between the input terminal and the output terminal; a logic circuit that receives a detection result signal from the reverse-current detection circuit; and a bias circuit that generates a bias current that operates the regulator control circuit. The logic circuit supplies the bias circuit with a potential that turns on or off generation of the bias current by the bias circuit, based on the detection result signal from the reverse-current detection circuit.

### CROSS-REFERENCE TO RELATED APPLICATION

This application is based upon and claims the benefit of priority from the prior Japanese Patent Application No. 2025-020685, filed on Feb. 12, 2025, the entire contents of which are incorporated herein by reference.

### BACKGROUND OF THE INVENTION

### Technical Field

The present invention relates to a power supply control device that includes a reverse-current prevention circuit. Specifically, the present invention relates to a technology that is effectively applicable to a linear regulator including an output control transistor connected between an input terminal and an output terminal.

### Description of Related Art

A linear regulator (hereinafter referred to as a regulator) is a power supply device that outputs a DC voltage having a desired potential by controlling an output control transistor provided between a DC voltage input terminal and an output terminal. Such a regulator includes a semiconductor integrated circuit (semiconductor device for controlling power supply) provided with a control circuit. The control circuit includes an error amplifier, for example, and generates a voltage for controlling the output control transistor according to the output voltage.

There are cases where the output voltage of the regulator is higher than the input voltage. In such cases, reverse currents may flow from the output terminal toward the input terminal or the ground terminal. When relatively great reverse currents keep flowing, the IC may be broken. For example, when the output control transistor is a MOS transistor, reverse currents flow through a parasitic diode formed between the drain and the back gate. For another example, when the output control transistor is a bipolar transistor, reverse currents flow through a parasitic diode formed between the collector and the base.

To prevent flow of reverse currents from the output terminal toward the input terminal through such a parasitic diode, a known regulator includes a transistor for preventing reverse currents (for example, see Japanese Unexamined Patent Application Publication No. Sho 63-307510). The transistor for preventing reverse currents is connected in parallel with an output control transistor and a reverse-current detection circuit that detects the state where the output voltage is higher than the input voltage. Further, Japanese Patent No. 7341196 describes an invention related to a power supply device including a reverse-current detection circuit.

The regulator described in JP Sho 63-307510A can detect occurrence of a reverse current state and prevent flow of reverse currents. However, according to JP Sho 63-307510A, currents keep flowing to a control circuit (error amplifier) that controls the output control transistor and a current source circuit (bias circuit) that supplies operational currents to the control circuit.

### SUMMARY OF THE INVENTION

The present invention has been conceived in view of the above-mentioned challenges. An object of the present invention is to provide a power supply control device and a semiconductor device for controlling power supply (power supply control IC) that can prevent flow of reverse currents from an output terminal and prevent flow of currents to a bias circuit and a control circuit when the output voltage is higher than the input voltage by a predetermined potential or more.

To achieve the above object, according to the present invention, a power supply control device includes: a first transistor that is connected between an input terminal and an output terminal and that controls a current supplied from the input terminal to the output terminal; a regulator control circuit that detects a voltage of the output terminal and controls the first transistor so that the voltage of the output terminal is at a constant level; a reverse-current detection circuit that detects a reverse current state between the input terminal and the output terminal; a logic circuit that receives a detection result signal from the reverse-current detection circuit; and a bias circuit that generates a bias current that operates the regulator control circuit, wherein the logic circuit supplies the bias circuit with a potential that turns on or off generation of the bias current by the bias circuit, based on the detection result signal from the reverse-current detection circuit.

### BRIEF DESCRIPTION OF DRAWINGS

The accompanying drawings are not intended as a definition e limits of the invention but illustrate embodiments of the invention, and together with the general description given above and the detailed description of the embodiments given below, serve to explain the principles of the invention, wherein:

FIG. 1 is a circuit configuration diagram showing an embodiment of a linear-regulator type power supply device to which the power supply control device of the present invention is applied;

FIG. 2 is a logic diagram as an example of a logic circuit that constitutes the power supply control device of the regulator in the embodiment;

FIG. 3 is a graph showing the relation between reverse currents and differences between input and output voltages of the regulator in the embodiment;

FIG. 4 is a circuit configuration diagram showing a modification of the regulator IC in the embodiment;

FIG. 5A is a circuit configuration diagram of the regulator IC that was conceived prior to the present invention; and

FIG. 5B is a circuit configuration diagram of the regulator IC that was conceived prior to the present invention.

### DETAILED DESCRIPTION

Hereinafter, a suitable embodiment of the present invention will be described based on the drawings.

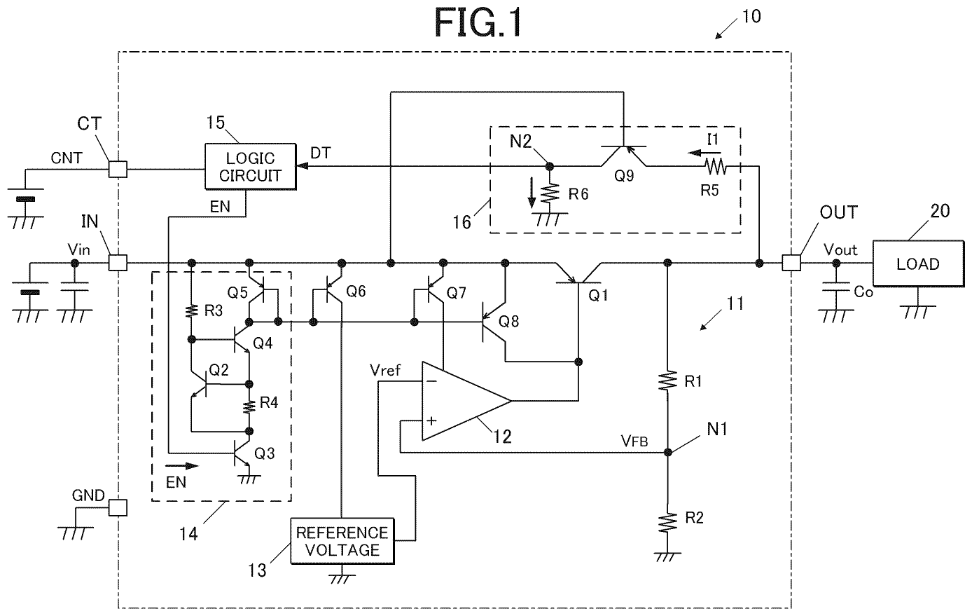

FIG. 1 shows an embodiment of a linear-regulator type power supply device to which the power supply control device of the present invention is applied. In FIG. 1, the part defined by a dash-dot line is formed as a semiconductor integrated circuit (regulator IC) 10 on a semiconductor chip made of single crystal silicon, for example. The output terminal OUT of the regulator IC 10 is connected to a capacitor Co. Thus, the regulator IC 10 functions as a DC power supply device that outputs a stable DC voltage Vout to a load 20.

As shown in FIG. 1, in the power supply device of this embodiment, a PNP bipolar transistor Q1 for controlling output is connected between the voltage input terminal IN and the output terminal OUT of the regulator IC 10. The voltage input terminal IN receives a DC input voltage Vin. Between the output terminal OUT and a ground line (ground point) to which the ground potential GND is applied, resistors R1 and R2 are connected in series. The resistors R1 and R2 constitute a voltage divider circuit 11 that divides the output voltage Vout.

The voltage of the connection node N1 connecting the resistors R1 and R2, which constitute the voltage divider circuit 11, is input as a feedback voltage VFB to the non-inverting input terminal of an error amplifier 12. The error amplifier 12 is an error amplifier circuit that controls the base terminal of the output control transistor Q1. To the inverting input terminal of the error amplifier 12, a predetermined reference voltage Vref is applied by a reference voltage circuit 13. The reference voltage circuit 13 generates the reference voltage Vref, based on the input voltage Vin. The error amplifier 12 generates a voltage corresponding to the potential difference between the feedback voltage VFB, which is the feedback of the output voltage, and the reference voltage Vref and supplies the generated voltage to the base terminal of the output control transistor Q1. Thus, the error amplifier 12 regulates the output voltage Vout at a desired potential.

The regulator IC 10 of this embodiment further includes a bias circuit 14 that generates operational currents for the error amplifier 12 and the reference voltage circuit 13.

The bias circuit 14 includes resistors R3 and R4 and NPN bipolar transistors Q2, Q3, and Q4. The resistor R3 and the transistors Q2 and Q3 are connected in series between the voltage input terminal IN and the ground point. The resistor R4 is connected between the base terminal and the emitter terminal of the transistor Q2. The base terminal of the transistor Q4 is connected to the collector terminal of the transistor Q2. The emitter terminal of the transistor Q4 is connected to the base terminal of the transistor Q2.

Between the collector terminal of the transistor Q4 and the voltage input terminal IN, a primary-side PNP bipolar transistor Q5 constituting a current mirror circuit is connected. Between the voltage input terminal IN and the reference voltage circuit 13 and between the voltage input terminal IN and the error amplifier 12, PNP bipolar transistors Q6, Q7, and Q8 are provided. The transistors Q6, Q7, and Q8 are in common base connection with the transistor Q5 and operate as the secondary-side current source of the current mirror circuit. The transistor Q8 operates as the current source for the output stage of the error amplifier 12 and effectively stabilizes the output voltage of the error amplifier 12. Although the transistor Q8 is depicted outside the error amplifier 12 in FIG. 1, the transistor Q8 can be viewed as constituting the error amplifier 12.

The regulator IC 10 of this embodiment is provided with a control input terminal CT as an external terminal. The control input terminal CT receives a control signal CNT supplied from a non-illustrated microcontroller or the like for controlling the operational state of the internal circuit of the IC. The regulator IC 10 further includes a logic circuit 15. The logic circuit 15 generates a signal EN to control the operation of the bias circuit 14, based on the control signal CNT from the control input terminal CT. The signal EN output by the logic circuit 15 is input to the base terminal of the transistor Q3. When the transistor Q3 is on, the bias circuit 14 is in operation. When the transistor Q3 is off, the bias circuit 14 is not in operation.

Define the voltage between the base and the emitter of the transistor Q2 as VF, and the resistance value of the resistor R3 as R. When the transistor Q3 is turned on by the signal EN of the logic circuit 15, a collector current flows through the transistor Q2, and a current I (I=VF/R) flows from the current source (the primary-side transistor Q5 of the current mirror circuit) connected to the collector terminal of the transistor Q4. Thus, the internal circuit (the error amplifier 12 and the reference voltage circuit 13) can be turned into operation. When the transistor Q3 is turned off by the signal EN of the logic circuit 15, no current flows through the transistor Q2, and the current I supplied from the transistor Q5, which is connected to the collector terminal of the transistor Q3, becomes zero. Accordingly, the internal circuit stops operating.

In this embodiment, a reverse-current detection circuit 16 is provided. The reverse-current detection circuit 16 monitors the voltage Vin at the voltage input terminal IN and the voltage Vout at the output terminal OUT and detects a reverse-current state in which Vout is higher than Vin by Vf or more. The detection signal of the reverse-current detection circuit 16 is input to the logic circuit 15. The logic circuit 15 takes the logical sum of the input control signal CNT of the control input terminal CT and the detection signal DT of the reverse-current detection circuit 16 and generates the signal EN for turning on/off the bias circuit 14.

The reverse-current detection circuit 16 includes a resistor R5, a PNP bipolar transistor Q9, and a resistor R6 that are connected in series between the output terminal OUT and the ground point. The base terminal of the transistor Q9 is connected to the voltage input terminal IN. The connection node N2 connecting the transistor Q9 and the resistor R6 is connected to the input terminal of the logic circuit 15.

When the voltage Vout at the output terminal OUT is higher than the voltage Vin at the input terminal IN by Vf or more, namely when Vout>(Vin+Vf) is satisfied, the transistor Q9 of the reverse-current detection circuit 16 turns on; a current flows through the resistor R6; and the potential of the connection node N2 between the transistor Q9 and the resistor R6 increases. Accordingly, a high-level signal is input to the input terminal of the logic circuit 15.

Although the resistor R5 can be omitted, the resistor R5 allows adjustment of the voltage Vf that provides the threshold for the transistor Q9 to change from OFF to ON. Therefore, the resistor R5 may be provided as a circuit that includes multiple resistor elements connected in parallel. By connecting or disconnecting any of the resistor elements, the resistance value of the resistor R5 can be changed. For another example, the resistor R5 may be configured as an external resistor having any desired resistance value and connectable to an external terminal of the IC. With such a resistor R5, the voltage Vf can be adjusted according to the system to which the power supply device of this embodiment is applied.

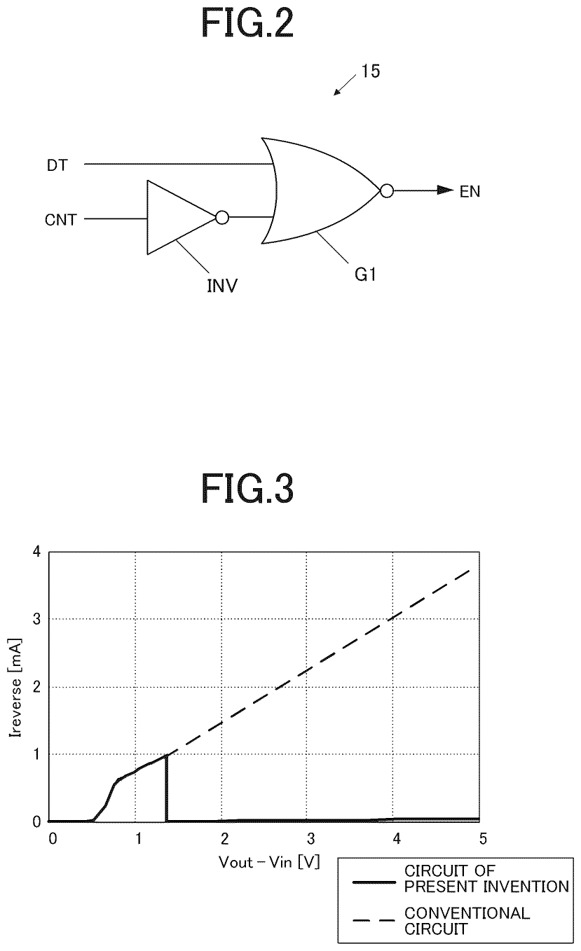

FIG. 2 is a logic configuration diagram as an example of the logic circuit 15. The following Table 1 is a truth table that shows the relation among the input control signal CNT, the detection signal DT of the reverse-current detection circuit 16, and the signal EN output by the logic circuit 15.

TABLE 1

| DT | CNT | EN |
|---|---|---|
| H | H | L |
| H | L | L |
| L | L | L |
| L | H | H |

As shown in FIG. 2, the logic circuit 15 includes an inverter INV1 and a NOR gate G1. The inverter INV1 inverts the input control signal CNT. The NOR gate G1 receives the output signal of the inverter INV1 and the detection signal DT of the reverse-current detection circuit 16 as inputs. The output of the logic circuit 15 changes to a high level (H) and the current of the bias circuit 14 flows, only when the input control signal CNT is high (H) and the detection signal DT of the reverse-current detection circuit 16 is low (L). In the other cases, the output of the logic circuit 15 remains low (L), and the current of the bias circuit 14 is shut off. As a result, supply of the operational current to the error amplifier 12 and the reference voltage circuit 13 is also shut off, and these circuits stop operating. Accordingly, the output control transistor Q1 is turned off. Thus, the reverse current flowing from the output terminal OUT toward the input terminal IN can be prevented.

As described above, according to the regulator IC of this embodiment, the current of the bias circuit 14 is shut off by the external control signal CNT, so that the error amplifier 12 and the reference voltage circuit 13 stop operating. Further, when the reverse-current detection circuit 16 detects the reverse current state, the current of the bias circuit 14 is shut off, so that the error amplifier 12 and the reference voltage circuit 13 stop operating.

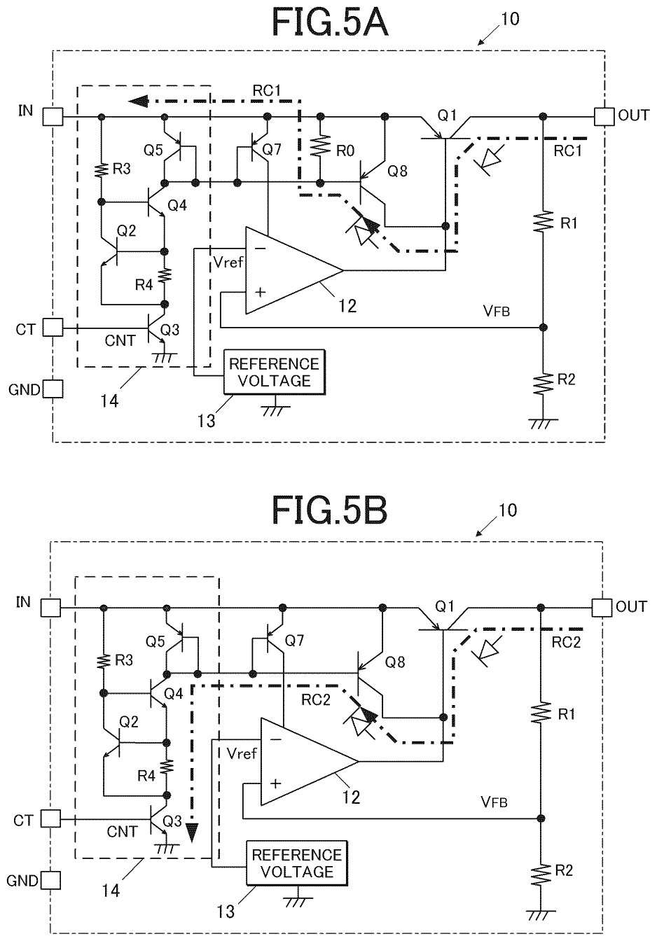

Further, the regulator IC of this embodiment can prevent the reverse current flowing toward the ground point via the parasitic PN junction diode formed between the collector and the base of the transistors Q1 and Q8. FIG. 3 shows the relation between the reverse current and the difference between the input voltage and the output voltage (Vout-Vin) of the regulator IC in this embodiment. In FIG. 3, the dashed line shows the relation between the input-output voltage difference (Vout-Vin) and the reverse current of a regulator IC shown in FIG. 5. The regulator IC of FIG. 5 was examined by the inventors prior to the present invention. FIG. 3 shows that, when the embodiment is not applied, the reverse current increases as the input-output voltage difference (Vout-Vin) increases. FIG. 3 also shows that, when the embodiment is applied, the reverse current is suppressed to values close to zero when the input-output voltage difference is equal to or greater than the predetermined voltage (Vf).

Next, the function of preventing the reverse current flowing through the parasitic PN junction diode of the transistors Q1 and Q8 is explained, based on the comparison with the circuits shown in FIG. 5A and FIG. 5B that were examined prior to the present invention.

The circuit of FIG. 5A includes a leak absorbing resistor R0. The leak absorbing resistor R0 turns off the current mirror circuit when the operation of the bias circuit 14 is stopped by the external control signal CNT. With the resistor R0, there is a possibility that a reverse current RC1 flows through the parasitic PN junction diode of the transistors Q1 and Q8 and the resistor R0 in the reverse current state.

To deal with this, the inventors considered removing the leak absorbing resistor R0, as shown in the circuit of FIG. 5B. However, it turned out that, according to the circuit without the leak absorbing resistor R0 in FIG. 5B, a reverse current RC2 flows through the parasitic PN junction diode of the transistors Q1, Q8 and the bias circuit 14 toward the ground point when the bias circuit 14 is in the ON state by the control signal CNT.

The present invention has been conceived to solve the above challenges. According to the regulator IC of the above embodiment that includes the reverse-current detection circuit 16, the bias circuit 14 stops operating in the reverse current state. Thus, the reverse current from the output terminal toward the ground point can be prevented.

According to the regulator IC of this embodiment, in the reverse current state, a current flows through the parasitic PN junction diode formed between the collector and the base of the transistor Q9, which constitutes the newly provided reverse-current detection circuit 16, toward the ground point. This current can be reduced to a small value by the use of an element having a high resistance value as the resistor R6.

### (Modification)

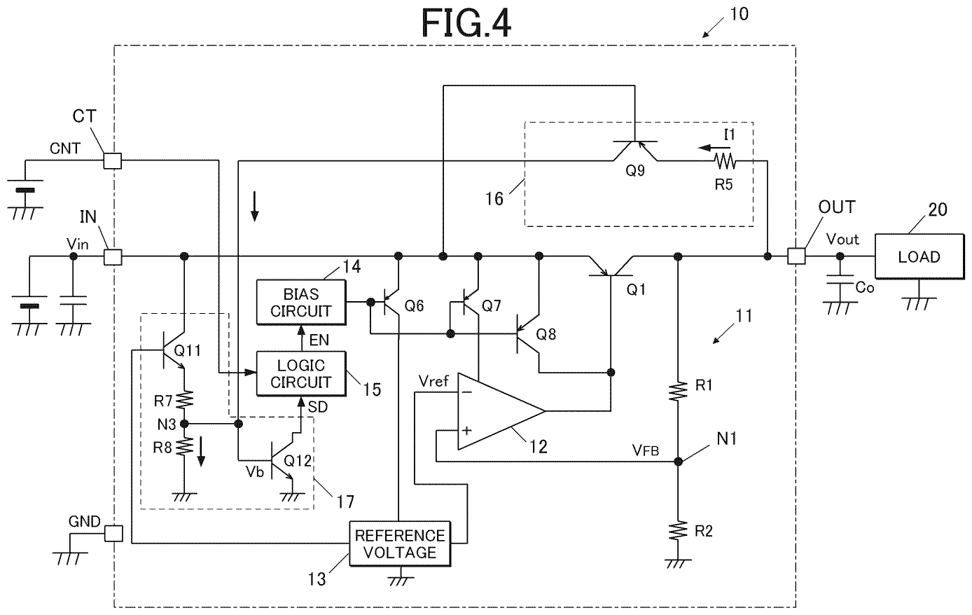

Next, a modification of the regulator IC of the above embodiment is described with reference to FIG. 4.

The regulator IC in the modification of FIG. 4 is different from the regulator IC 10 in the embodiment of FIG. 1 in that: a thermal shutdown (TSD) circuit 17 that detects an increase in chip temperature is provided; the resistor R6 of the reverse-current detection circuit 16 is omitted; and the collector of the transistor Q9 is connected to an internal node of the TSD circuit 17. Since the configuration of the bias circuit 14 in the modification is the same as in the regulator IC of the embodiment shown in FIG. 1, the detailed circuit configuration thereof is not illustrated. The output signal of the TSD circuit 17 is supplied to the logic circuit 15 that receives the input control signal CNT of the control input terminal CT. The logic circuit 15 in this modification can be a NAND gate different from the one in FIG. 2.

The TSD circuit 17 of the regulator IC in this modification includes NPN bipolar transistors Q11 and Q12 and resistors R7 and R8. The transistor Q11 and the resistors R7 and R8 are connected in series between the voltage input terminal IN and the ground point. The emitter of the transistor Q12 is connected to the ground point. The base of the transistor Q12 is connected to the connection node N3 connecting the resistors R7 and R8. The collector of the transistor Q12 serves as the output terminal of the TSD circuit 17.

The constant voltage of the reference voltage circuit 13 is applied to the base of the transistor Q11 of the TSD circuit 17, so that a current flows constantly. When the chip temperature rises, the potential of the node N3 rises. When the chip temperature is equal to or higher than a predetermined level, the transistor Q12 is turned on, and the output SD of the TSD circuit 17 becomes a low level. Accordingly, the logic circuit 15 stops the operation of the bias circuit 14.

In this modification, the connection node N3 between the resistors R7 and R8 is connected to the collector of the transistor Q9 of the reverse-current detection circuit 16. When Vout>(Vin+Vf) is satisfied, the transistor Q9 is turned on, and a current flows through the resistor R8 to the ground point, so that the potential of the node N3 rises. Thus, when the TSD circuit 17 does not detect a rise in chip temperature but the reverse-current detection circuit 16 detects the reverse current state, the output SD of the TSD circuit 17 changes to a low level, so that the operation of the bias circuit 14 is stopped.

Although FIG. 4 shows the modification including the TSD circuit 17, the regulator IC may include an abnormality detection circuit other than the TSD circuit 17, such as an overcurrent protection circuit or an overvoltage protection circuit, for example. The signal from the abnormality detection circuit may be input to the logic circuit 15, and the logic circuit 15 may stop the operation of the bias circuit 14 when an abnormality (e.g., overcurrent or overvoltage) occurs.

According to the above power supply control device, when the output voltage is higher than the input voltage by a predetermined potential or more, the output of the reverse current detection circuit changes, so that the logic circuit turns off the generation of bias current by the bias circuit. Therefore, in the reverse current state, the flow of current to the bias circuit and the regulator control circuit can be prevented. Further, the first transistor (output control transistor) is turned off. This can prevent the flow of the reverse current from the output terminal toward the input terminal.

According to the present invention, when the output voltage is higher than the input voltage by a predetermined potential or more, the power supply control device can prevent the flow of the reverse current from the output terminal and the flow of the current to the bias circuit and the control circuit.

Although the present invention has been described in detail based on the embodiment, the invention is not limited to the above embodiment. For example, although the present invention is applied to a regulator IC constituted by bipolar transistors in the above embodiment, the invention is also applicable to a regulator IC constituted by MOS transistors or a regulator IC constituted by both bipolar transistors and MOS transistors.

Further, although the reverse-current detection circuit 16 of the above embodiment includes the transistor Q9 and the resistor R6 connected in series as shown in FIG. 1, the reverse-current detection circuit 16 may be a differential-type voltage comparator circuit (comparator).

1. A power supply control device comprising:
a first transistor that is provided between an input terminal and an output terminal and that controls a current supplied from the input terminal to the output terminal;
a regulator control circuit that detects a voltage of the output terminal and controls the first transistor so that the voltage of the output terminal is at a constant level;
a reverse-current detection circuit that detects a reverse current state between the input terminal and the output terminal;
a logic circuit that receives a detection result signal from the reverse-current detection circuit; and
a bias circuit that generates a bias current that operates the regulator control circuit, wherein
the logic circuit supplies the bias circuit with a potential that turns on or off generation of the bias current by the bias circuit, based on the detection result signal from the reverse-current detection circuit.

2. The power supply control device according to claim 1, wherein:
the reverse-current detection circuit includes a second transistor and a first resistor connected in series between the output terminal and a constant potential point,
a base or a gate of the second transistor is connected to the input terminal, and
a voltage into which a current is converted by the first resistor is input as the detection result signal to the logic circuit.

3. The power supply control device according to claim 2, wherein when a difference between the voltage of the output terminal and a voltage of the input terminal is greater than a threshold voltage of the second transistor, the logic circuit supplies the bias circuit with a potential that turns off generation of the bias current by the bias circuit.

4. The power supply control device according to claim 3, further comprising a second resistor connected between the output terminal and an emitter or a source of the second transistor.

5. The power supply control device according to claim 1, further comprising an external control terminal, wherein
the logic circuit supplies the bias circuit with the potential that turns on or off generation of the bias current by the bias circuit, based on the detection result signal from the reverse-current detection circuit and an input signal from the external control terminal.

6. The power supply control device according to claim 5, further comprising an abnormality detection circuit that detects an abnormality, wherein
the logic circuit supplies the bias circuit with the potential that turns on or off generation of the bias current by the bias circuit, based on the detection result signal from the reverse-current detection circuit, the input signal from the external control terminal, and an abnormality detection signal from the abnormality detection circuit.
